(19) United States
(12) Patent Application Publication
(10) Pub. No.: US 2021/0008757 A1
(43) Pub. Date: Jan. 14, 2021

(54) DEVICE FOR APPLYING LAYERS OF PASTE FOR A MACHINE FOR MANUFACTURING CERAMIC PIECES BY STEREOLITHOGRAPHY

(71) Applicant: S.A.S 3DCeram-Sinto, LIMOGES (FR)

(72) Inventors: Christophe CHAPUT, LE PALAIS-SUR-VIENNE (FR); Richard GAIGNON, SAINT-VRAIN (FR); Marc NGUYEN, LE VIGEN (FR); Nicolas ROUSSELET, LIMOGES (FR)

(21) Appl. No.: 16/923,522

(22) Filed: Jul. 8, 2020

(30) Foreign Application Priority Data
Jul. 8, 2019 (FR) 1907636

(51) Int. Cl. B28B 1/00; B29C 64/135; B29C 64/214; B29C 64/268

(52) U.S. Cl. CPC B28B 1/001; B29C 64/135; B33Y 30/00; B29C 64/268; B29C 64/214

(57) ABSTRACT

A device for applying a paste in layers for a machine for manufacturing ceramic pieces by stereolithography, the device including a blade holder configured to be moved in translation; a blade element made of one of a blade and at least two parallel blades, the blade element being arranged on the blade holder and being configured to scrape, during the translational movement of the blade holder, a mass of paste brought in front of the blade element in order to spread the mass of paste into a layer; and a paste distributing component arranged in front of the blade element, wherein the paste distributing component consists of a shield for pushing the paste, the shield being formed of an elongate part including a vertical portion in assembled position on the device, the vertical portion of the shield being secured to the blade element while leaving the lower border region of the blade element free in order to allow the scraping of the paste, an upper portion of the elongated part being further folded in the direction of forward movement of the blade holder in order to form an overhanging portion, the lower face of the overhang constituting with the free face of the vertical portion of the pushing shield a containment area for the paste for the distribution and spreading of the paste.

### BACKGROUND OF THE INVENTION

### Field of the Invention

The present invention relates to the manufacturing of ceramic pieces by stereolithography. These ceramic pieces are crude pieces to be subjected to cleaning, debinding and sintering operations in order to obtain finished ceramic pieces.

### Description of the Related Art

Stereolithography generally comprises the following steps in order to obtain such crude pieces:
building, by computer aided design, a computer model of the piece to be manufactured, the dimensions of this model being larger than those of the piece to be manufactured so as to anticipate shrinking of ceramic material during the manufacturing of the piece;
forming, on a rigid support or on a piece being manufactured, a first layer of a photocurable composition generally comprising at least one ceramic material, at least one dispersant, at least one photocurable monomer and/or oligomer, at least one photoinitiator and at least one plasticizer;
curing the first layer of the photocurable composition, by irradiation according to a pattern defined from the model for said layer, forming a first stage;
forming, on the first stage, a second layer of the photocurable composition;
curing the second layer of the photocurable composition, by irradiation according to a pattern defined for said layer, to form a second stage,
   this irradiation being performed by laser scanning of the free surface of the spread photocurable composition or by a diode projection system;
optionally, repeating the above mentioned steps until the green piece is obtained.

In the case of manufacturing using paste, the rigid support is a working tray supporting the different layers of the piece being manufactured as well as the paste, and each of the layers is formed by lowering the working tray and spreading paste with a predefined thickness. A paste reserve is stored in tanks that are automatically emptied from a predefined amount of paste for each layer using a piston. This creates a paste bead to be spread on the top layer of the piece being manufactured, which will have been lowered beforehand by the working tray.

Each layer is spread by scraping by a scraping blade that sweeps the working surface of the working tray, for example by advancing in a rectilinear horizontal direction.

Under these conditions, layers are formed which are irregular and nonhomogeneous layers in terms of thickness, the thickness ranging from several tens of microns to several millimeters. As a result, the piece will not exhibit a correct outer appearance and unwanted internal stresses may appear within it, such that the manufactured pieces must be discarded.

Additionally, significant scraping forces may be generated, during the phase of construction by layers, such that the pieces break during their construction.

US patent U.S. Pat. No. 6,764,636 discloses a roller-based scraping device, allowing to give movement to the paste or to decrease its viscosity in order to prevent the paste from moving upward along the blade, the rollers making it possible to move the paste downward and make it available to the blade, supplying it homogeneously on the sides. However, this device is not suitable for highly pasty compositions and is not very convenient to use, due to the difficulty of cleaning it after use.

### SUMMARY OF THE INVENTION

The present invention aims to solve these drawbacks, namely to improve the lack of homogeneity of each spread layer of paste, to avoid excessive scraping forces which may destroy the pieces being built, and to make the cleaning of the scraping device easier.

To that end, it is provided, according to the invention, that the uniform spreading of the paste is provided by a part of a simple design, referred to as “pushing shield”, provided in front of the blade, advantageously having a half-arch profile or the like, delimiting an open space in the forward direction of the blade holder, such a space receiving the paste, with the paste being able to “recirculate” easily in the half-arch or the like for an homogeneous distribution over the entire length of the shield and all along the forward movement.

The present invention therefore first relates to a device for applying a paste in layers for a machine for manufacturing ceramic pieces by stereolithography, the device including:
a blade holder configured to be moved in translation;
a blade element made of one of a blade and at least two parallel blades, the blade element being arranged on the blade holder and being configured to scrap, during the translational movement of the blade holder, a mass of paste brought in front of the blade element in order to spread the mass of paste into a layer; and
a paste distributing component arranged in front of the blade element,
   wherein the paste distributing component consists of a shield for pushing the paste, the shield being formed of an elongate part including a vertical portion in assembled position on the device, the vertical portion of the shield being secured to the blade element while leaving the lower border region of the blade element free in order to allow the scraping of the paste, an upper portion of the elongated part being further folded in the direction of forward movement of the blade holder in order to form an overhanging portion, the lower face of the overhanging portion constituting with the free face of the vertical portion of the pushing shield a containment area for the paste for the distribution and spreading of the paste.

In the case where at least two parallel scraping blades are used, these may be joined to each other or spaced apart, their edges being arranged at stepped heights, the scraping edge of the leading blade being the highest with respect to the working surface.

According to different specific embodiments:
the free face of the vertical portion of the pushing shield is joined with the lower face of the overhanging portion by a curved region whose concavity faces the containment area;
the free edge region of the lower face of the overhanging portion of the pushing shield has a return toward the containment area to re-direct the paste downward during forward movement of the blade holder without closing the opening of the pushing shield;
the free face of the vertical portion of the pushing shield is one of vertical, curved with a concavity facing the containment area and inclined toward the inside of the containment area of the pushing shield;
the lower face of the overhanging portion of the pushing shield is horizontal and being one of planar and curved with a concavity facing the containment area.

The pushing shield can advantageously occupy the entire width of the blade element.

According to an interesting particular feature, each end of the pushing shield is closed by a closing plate, it being possible for the closing plate to extend past the containment area to ensure guiding of the paste toward the containment area of the pushing shield. Advantageously, the inner faces of the closing plates can be inclined toward the outside of the containment area to facilitate the guiding of the paste entering the containment area.

The present invention also relates to a gantry configured to move above a working tray of a machine for manufacturing ceramic pieces by stereolithography, wherein the gantry includes at least one device as defined above, arranged such that the free edge of the blade element is configured to spread, by scraping, layers of paste on the working surface, the device being configured to be held and moved in a high position, raised above the working plane, when the associated blade element is not active.

The gantry according to the invention can include first and second devices as defined above, the first device being active for scraping in a forward direction, and the second device being active for scraping in the opposite direction. In this arrangement, the two blade holders are arranged parallel to one another, and the blade(s) associated with each blade holder are advantageously arranged opposite one another while facing outward.

The present invention also relates to a machine for manufacturing crude parts from ceramic material by stereolithography, by successively curing layers of a thermosetting paste by irradiation according to a predefined pattern for each layer, the machine comprising:
a frame surrounding a horizontal working tray including a working surface;
a gantry as defined above; and
a laser irradiation device facing the working tray to irradiate each layer once the layer is spread so as to cure the layer according to the pattern previously defined before spreading the following layer, the following layer being in turn cured according to the predefined pattern.

### BRIEF DESCRIPTION OF THE DRAWINGS

For a better understanding of the subject-matter of the present invention, several illustrative and non limiting embodiments will be described below, in reference to the appended drawing.

In these drawing:

FIG. 1 is a schematic perspective front view showing a device according to a first embodiment of the present invention;

FIG. 2 is an enlarged view of the region in the bottom left of FIG. 1 delimited, in the front, by a sectional view in a vertical plane;

FIG. 3 is a front view of the device of FIG. 1;

FIG. 4 is a rear view of the device of FIG. 1;

FIG. 5 is a vertical sectional view of the blade portion+paste distributor according to a second embodiment of the present invention;

FIG. 6 is a bottom view of the paste distributor of FIG. 5;

FIG. 7 is a vertical sectional view of the blade portion+paste distributor according to a third embodiment of the present invention; and

FIG. 8 is a bottom view of the paste distributor of FIG. 7.

### DESCRIPTION OF THE PREFERRED EMBODIMENTS

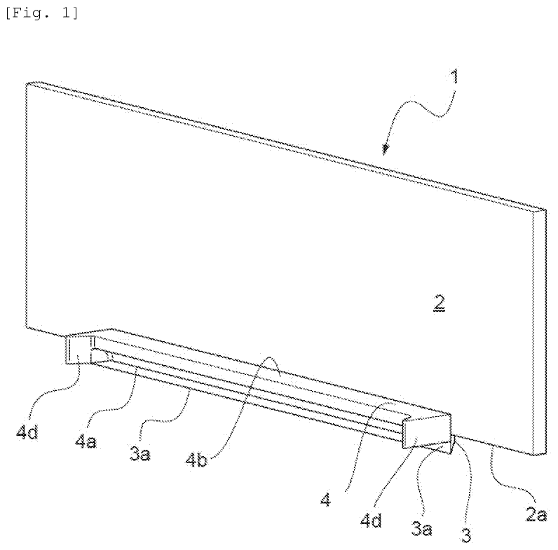

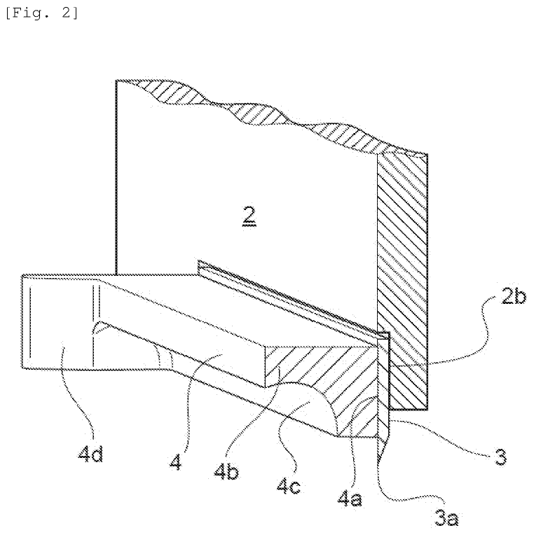

FIGS. 1 to 4 schematically show a device 1 according to a first embodiment of the invention for the application, in layers, of a pasty material according to a method for manufacturing ceramic pieces by stereolithography.

The device 1 includes a blade holder 2, a blade 3 carried in the front by the latter, and a paste distributor 4 mounted in front of the blade 3.

The blade holder 2 is shown here schematically in the form of a simple rectangular plate made from metal or rigid plastic.

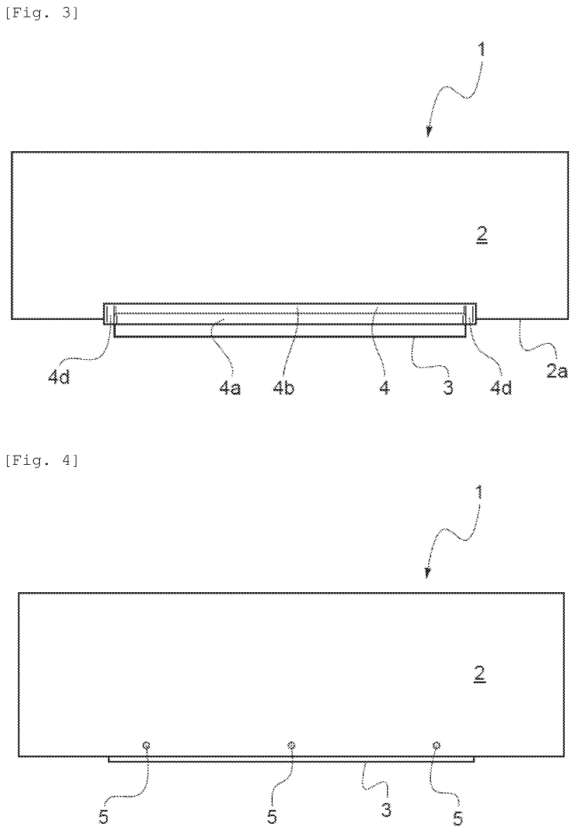

A central rectangular indentation 2b is formed along the lower edge 2a of the front face of the blade holder 2, in its advance position, the central rectangular indentation 2b receiving the blade 3, which is held in the indentation 2b by screws 5 that pass through the blade holder 2 by its rear face (FIG. 4). The blade 3 protrudes in the lower part of the blade holder 2 so that its edge 3a can perform the scraping.

The paste distributor 4 is arranged in front of the blade 3, said paste distributor 4 consisting of an elongated part made from metal or plastic or ceramic in the form of a pushing shield for the paste.

The pushing shield 4 has a portion 4a, which is vertical in the mounted position, that is pressed against the blade 3 and an overhanging horizontal portion 4b, which forms a so-called containment area 4c for the paste at the front.

The area 4c is delimited by an arc of circle-shaped wall, the pushing shield thus being in the general shape of a half-arch.

The paste that is brought in front of the pushing shield will be distributed all along the pushing shield over the course of the pushing exerted by the blade holder 2 moving forward. The paste will also tend to be re-directed downward in order to “circulate” and ensure a better distribution.

The pushing shield 4 is also closed at each of its both ends by a closing plate or wing 4d perpendicular to the longitudinal midline thereof, each plate 4d extending forward beyond the containment area 4c.

The inner faces of the closing plates 4d are inclined toward the outside, which makes it possible to facilitate the guiding of the paste in the containment area 4c.

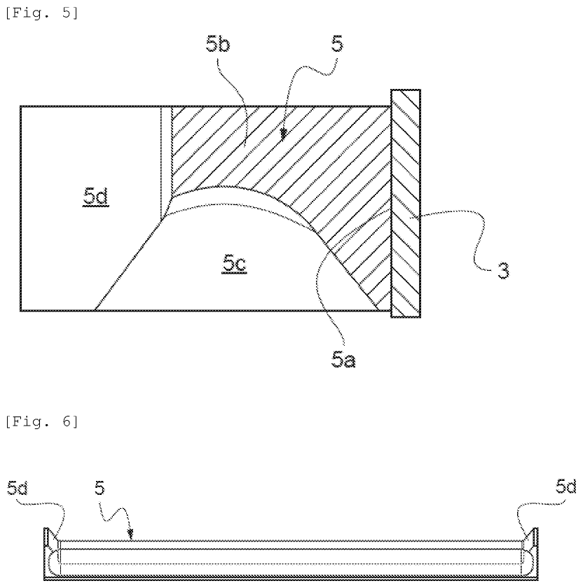

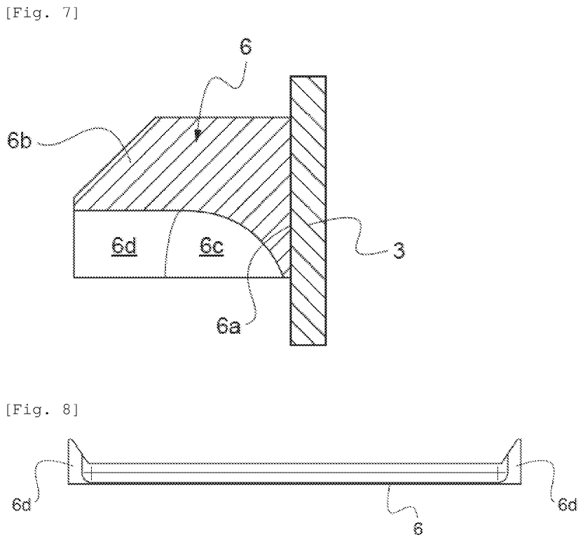

FIGS. 5 and 7 show variant embodiments of the pushing shield 4, the pushing shields being referenced by reference numbers 5 and 6, respectively, with the associated indexes for the different portions of the shield.

The shape of the containment area 5c of the shield 5 can be contemplated as conical, upwardly rounded. It has been operating fully satisfactorily.

The shape of the containment area 6c can be contemplated as rounded, open toward the front. It has also been operating fully satisfactorily.

1- A device for applying a paste in layers for a machine for manufacturing ceramic pieces by stereolithography, the device including:
a blade holder configured to be moved in translation;
a blade element made of one of a blade and at least two parallel blades, the blade element being arranged on the blade holder and being configured to scrape, during the translational movement of the blade holder, a mass of paste brought in front of the blade element in order to spread the mass of paste into a layer; and
a paste distributing component arranged in front of the blade element,
wherein the paste distributing component consists of a shield for pushing the paste, the shield being formed of an elongate part including a vertical portion in assembled position on the device, the vertical portion of the shield being secured to the blade element while leaving the lower border region of the blade element free in order to allow the scraping of the paste, an upper portion of the elongated part being further folded in the direction of forward movement of the blade holder in order to form an overhanging portion, the lower face of the overhanging portion constituting with the free face of the vertical portion of the pushing shield a containment area for the paste for the distribution and spreading of the paste.

2- The device according to claim 1, wherein the free face of the vertical portion of the pushing shield is joined with the lower face of the overhanging portion by a curved region whose concavity faces the containment area.

3- The device according to claim 1, wherein the free edge region of the lower face of the overhanging portion of the pushing shield has a return toward the containment area to re-direct the paste downward during forward movement of the blade holder without closing the opening of the pushing shield.

4- The device according to claim 1, wherein the free face of the vertical portion of the pushing shield is one of vertical, curved with a concavity facing the containment area and inclined toward the inside of the containment area of the pushing shield

5- The device according to claim 1, wherein the lower face of the overhanging portion of the pushing shield is horizontal and being one of planar and curved with a concavity facing the containment area.

6- The device according to claim 1, wherein the pushing shield occupies the entire width of the blade element.

7- The device according to claim 1, wherein each end of the pushing shield is closed by a closing plate.

8- The device according to claim 7, wherein the closing plate extends past the containment area to ensure guiding of the paste toward the containment area of the pushing shield.

9- The device according to claim 7, characterized in that the inner faces of the closing plates are inclined toward the outside of the containment area to facilitate the guiding of the paste entering the containment area.

10- A gantry configured to move above a working tray of a machine for manufacturing ceramic pieces by stereolithography, wherein the gantry includes at least one device as defined in claim 1, arranged such that the free edge of the blade element is configured to spread, by scraping, layers of paste over the working surface, the device being configured to be held and moved in a high position, raised above the working plane, when the associated blade element is not active.

11- The gantry according to claim 9, wherein the gantry includes first and second devices as defined in claim 1, the first device being active for scraping in a forward direction, and the second device being active for scraping in the opposite direction.

12- A machine for manufacturing crude parts from ceramic material by stereolithography by successively curing layers of a thermosetting paste by irradiation according to a predefined pattern for each layer, the machine comprising:
a frame surrounding a horizontal working tray including a working surface;
a gantry as defined in claim 9; and
a laser irradiation device facing the working tray to irradiate each layer once the layer is spread so as to cure the layer according to the pattern previously defined before spreading the following layer, the following layer being cured according to the predefined pattern.

13- A machine for manufacturing crude parts from ceramic material by stereolithography by successively curing layers of a thermosetting paste by irradiation according to a predefined pattern for each layer, the machine comprising:
a frame surrounding a horizontal working tray including a working surface;
a gantry as defined in claim 10; and
a laser irradiation device facing the working tray to irradiate each layer once the layer is spread so as to cure the layer according to the pattern previously defined before spreading the following layer, the following layer being cured according to the predefined pattern.
